(19) United States
(12) Patent Application Publication
(10) Pub. No.: US 2023/0244037 A1
(43) Pub. Date: Aug. 3, 2023

(54) Waveguide Type Optical Switching Circuit and Driving Method Thereof

(71) Applicant: Nippon Telegraph and Telephone Corporation, Tokyo (JP)

(72) Inventors: Osamu Moriwaki, Musashino-shi, Tokyo (JP); Kenya Suzuki, Musashino-shi, Tokyo (JP)

(21) Appl. No.: 17/794,078

(22) PCT Filed: Jan. 24, 2020
(86) PCT No.: PCT/JP2020/002515

§ 371 Date: Dec. 2, 2022

(51) Int. Cl. G02B 6/35; G02B 6/43; G02B 6/42

(52) U.S. Cl. CPC G02B 6/3596; G02B 6/43; G02B 6/4268; G02B 6/357

(57) ABSTRACT

For waveguide type optical switch circuits, there is a problem in that both reduction in time required for switching and switching-back and reduction in power consumption cannot be achieved. One embodiment of a waveguide type optical switch circuit includes: a waveguide that has a clad layer stacked on a substrate and a waveguide core embedded in the clad layer; a heater that is formed on an upper surface of the clad layer above the waveguide core; and a groove that is obtained by removing the clad layer in a vertical direction of the substrate and has a surface parallel to a side surface of the waveguide core. A distance X between the waveguide core and the heater is designed to be equal to or greater than a distance Y between the heater and the groove (X≥Y)

### TECHNICAL FIELD

The present invention relates to a waveguide type optical switch circuit and a driving method for the waveguide type optical switch circuit. More specifically, the present invention relates to a waveguide type optical switch circuit which is a waveguide type optical device used for optical communication networks to switch propagation paths of optical signals and which needs a short time for switching and switching-back.

### BACKGROUND ART

With the proliferation of the Internet, demand for data communication networks is exploding, and it is necessary to increase the capacity of network components such as packet routers and packet switches. The power consumption of such packet routers and packet switches has significantly increased with increased capacity, and is expected to increase explosively in the future. However, the power available for station facilities of the networks is limited, and power saving of network components is therefore a challenge. For packet routers and packet switches, power saving is expected through application of optical switches that need a short time for switching and switching-back.

FIG. 1 shows a configuration of a conventional waveguide type optical switch circuit. This waveguide type optical switch circuit is composed of a two-input/two-output base element 400 and is an optical circuit of Mach-Zehnder interferometer (MZI) type. The two-input/two-output base element 400 includes an optical splitter 401 that branches input signals, an optical coupler 402 that makes outputs of the optical splitter 401 recombine, interfere, and output, two waveguides 404 that connect the optical splitter 401 and the optical coupler 402, and heaters 403 that are formed directly above at least one of the waveguides 404.

In the case that the upper port of the optical splitter 401 serves as an input port, and the two waveguides connecting the optical splitter 401 and the optical coupler 402 are of equal length, when power is not supplied to the heaters 403, inputted optical signals are outputted from the lower port of the optical coupler 402. When power is supplied to one of the heaters 403 to heat one of the waveguides 404 so that the refractive index is changed due to the thermo-optic effect of the waveguide material to change the optical path length by λ/2 with respect to the wavelength λ of the signal light, inputted optical signals are outputted from the upper port of the optical coupler 402. Alternatively, the two waveguides 404 may have different optical path lengths by λ/2 in advance, and then inputted optical signals may be outputted from the upper port of the optical coupler 402 under the condition that power is not supplied and from the lower port under the condition that power is supplied.

FIG. 2 shows a driving method for such a conventional waveguide type optical switch circuit. This driving method is intended to reduce the time required for switching and switching-back in the base element 400 shown in FIG. 1. The heaters 403 are formed to the two waveguides 404 of the base element 400 respectively, and one heater is described as heater 403-1 and the other heater is described as heater 403-2.

A waveform of the applied voltage to the one heater 403-1 is shown on the upper side of FIG. 2. At the timing of switching, a voltage V₁ sufficiently higher than a voltage V₂ required to change the optical path length by λ/2 is applied for a short period of time T₁. After the lapse of T₁, a pulsed voltage is repeatedly applied in a cycle period T sufficiently shorter than the thermal response time constant of the waveguide material. Here, the time in which the voltage V₁ is applied during one cycle is shorter than T, for example, T×(V₂/V₁)². Because a large amount of heat is supplied at the start of switching, the amount of change in the optical path length reaches λ/2 in a short time. After that, considering the time-average voltage, the waveguide is heated with the same work load as that when the voltage V₂ is applied, and consequently, the change in the optical path length of λ/2 is maintained. The applied voltage is set to zero at the timing of switching-back.

A waveform of the applied voltage to the other heater 403-2 is shown on the lower side of FIG. 2. At the timing of switching-back, a voltage V₃ sufficiently higher than the voltage V₂ is applied for a short period of time T₂. After the lapse of T₂, the applied voltage is set to zero. Because a large amount of heat is supplied at the start of switching-back so that the two waveguides 404 have the same amount of change in optical path length of in a short time, switching-back is achieved in a shorter time than that in natural heat radiation. After that, the two waveguides 404 is allowed to naturally radiate heat while maintaining their changes in their optical path lengths equal and to consequently return to the initial state maintaining the switching-back state.

FIG. 3(a) shows an example of simulation of temperature change in switching in the conventional waveguide type optical switch circuit. In this example, the driving method shown in FIG. 2 is applied to reduce the time required for switching of the base element of the quartz-based waveguide type optical switch circuit. FIG. 3(a) illustrates the temperatures of the waveguides located below the heater 403-1 and the heater 403-2, and the time when the application of voltage is started to the heater 403-1 in switching of the optical switch is regarded as zero. The horizontal axis represents time and the vertical axis represents temperature. Similarly, FIG. 3(b) shows an example for reducing the time required for switching-back, and illustrates the temperatures of the waveguides located below the heater 403-1 and the heater 403-2, and the time when the application of voltage is started to the heater 403-2 in switching-back of the optical switch is regarded as zero.

As for the temperature changes of the waveguides shown in FIG. 3(a), in switching, the temperature of the waveguide located below the heater 403-1 once reaches a desired temperature. After that, the temperature temporarily decreases and then shifts to the thermal equilibrium state. When such temperature changes occur, the optical switch seems to be switched once in switching, but the transmittance (light output level) then decreases for a short time.

In switching-back shown in FIG. 3(b), the temperature of the waveguide located below the heater 403-2 once reaches a temperature substantially equal to the temperature of the waveguide located below the heater 403-1, and then decreases more quickly than the temperature of the waveguide located below the heater 403-1. After that, both waveguides reach the temperature of the substrate. When the temperature changes of the two waveguides are different in this way, the optical switch seems to be switched back once in switching-back, but leakage light then occurs for a short time.

Therefore, when such a conventional method, in which a high voltage is applied to the heater for a short time to reduce the time for switching and switching-back, is applied to a quartz-based waveguide type optical switch circuit, there is a problem in that a desirable operation for switching and switching-back of an optical switch is not achieved.

### CITATION LIST

### Non-Patent Literature

Non-Patent Literature 1: H. Matsuura et al., “Accelerating switching speed of thermo-optic MZI silicon-photonic switches with “turbo pulse” in PWM control,” 2017 Optical Fiber Communications Conference and Exhibition

### SUMMARY OF THE INVENTION

An object of the present invention is to provide a waveguide type optical switch circuit that reduces a time required for switching and switching-back in a quartz-based waveguide type optical switch circuit, stabilizes optical output after switching, and does not cause leakage light after switching-back.

To achieve such an object, one embodiment of a waveguide type optical switch circuit includes a waveguide that has a clad layer stacked on a substrate and a waveguide core embedded in the clad layer, a heater that is formed on an upper surface of the clad layer above the waveguide core, and a groove that is obtained by removing the clad layer in a vertical direction of the substrate and has a surface parallel to a side surface of the waveguide core. A distance X between the waveguide core and the heater is equal to or greater than a distance Y between the heater and the groove (X≥Y).

An embodiment of a waveguide type optical switch circuit of Mach-Zehnder interferometer type, which includes an optical splitter that branches input signals, an optical coupler that makes outputs of the optical splitter recombine, interfere, and output, and two arm waveguides that connect the optical splitter and the optical coupler, each arm waveguide having a clad layer stacked on a substrate and a waveguide core embedded in the clad layer, includes heaters that are formed on an upper surface of the clad layer above the waveguide cores, and grooves that are obtained by removing the clad layer in a vertical direction of the substrate, each of the grooves having a surface parallel to a side surface of the waveguide core. A distance X between the waveguide core and the heater is equal to or greater than a distance Y between the heater and the groove (X≥Y).

### BRIEF DESCRIPTION OF DRAWINGS

FIG. 1 shows a configuration of a conventional waveguide type optical switch circuit.

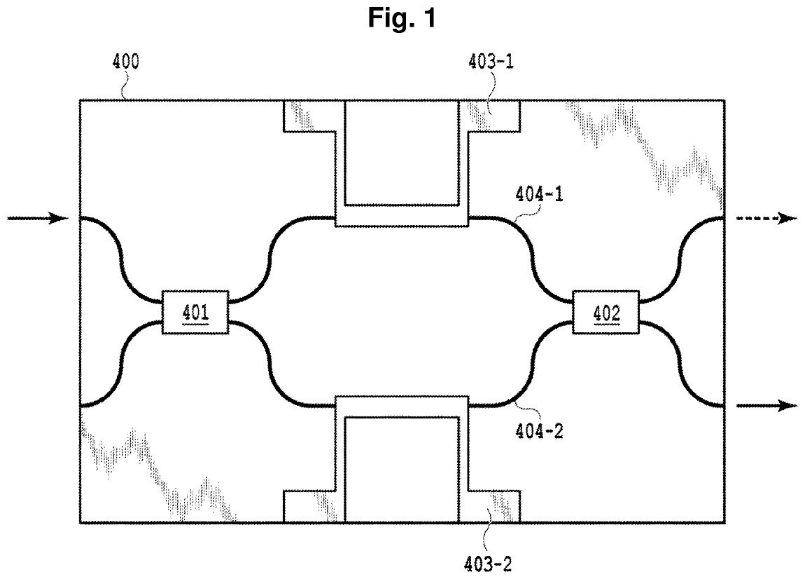

FIG. 2 shows a driving method for the conventional waveguide type optical switch circuit.

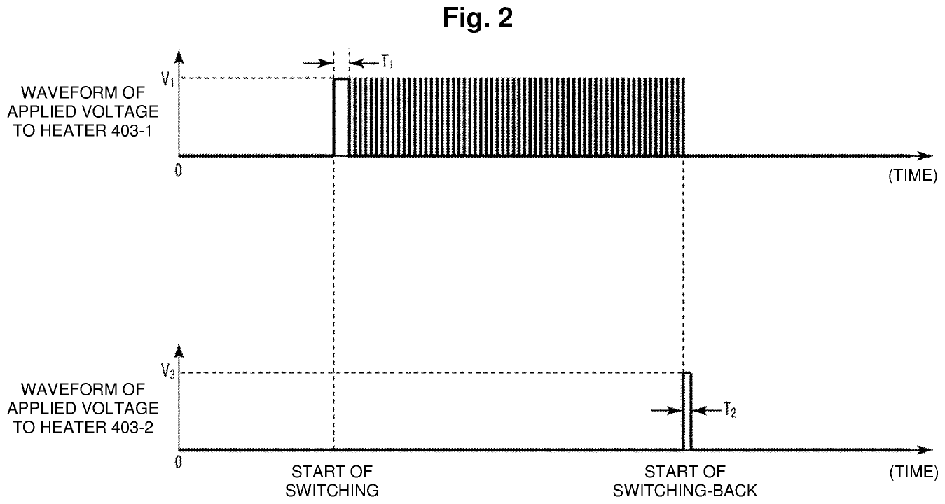

FIG. 3(a) shows an example of simulation of temperature change in switching in the conventional waveguide type optical switch circuit, and FIG. 3(b) shows an example of simulation of temperature change in switching-back.

FIG. 4(a) is a planar view of a configuration of a waveguide type optical switch circuit according to a first embodiment of the present invention, and FIG. 4(b) is a cross-sectional view of the waveguide type optical switch circuit.

FIG. 5 is a timing diagram of switching and switching-back of an output port of the waveguide type optical switch circuit according to the first embodiment.

FIG. 6(a) shows isothermal lines in a cross section of the waveguide type optical switch circuit according to the first embodiment which has no heat insulating groove and is in the thermal equilibrium state, FIG. 6(b) shows isothermal lines in the waveguide type optical switch circuit which has no heat insulating groove after heating with a voltage pulse, FIG. 6(c) shows isothermal lines in the waveguide type optical switch circuit which has heat insulating grooves in the thermal equilibrium state, and FIG. 6(d) shows isothermal lines in the waveguide type optical switch circuit which has heat insulating grooves after heating with a voltage pulse.

FIG. 7(a) shows an example of simulation of temperature change in switching in the waveguide type optical switch circuit according to the first embodiment, and FIG. 7(b) shows an example of simulation of temperature change in switching-back.

FIG. 8 is a timing diagram of switching and switching-back of an output port of a waveguide type optical switch circuit according to a second embodiment of the present invention.

### DESCRIPTION OF EMBODIMENTS

Hereinafter, embodiments of the present invention will be described in detail with reference to the drawings.

### First Embodiment

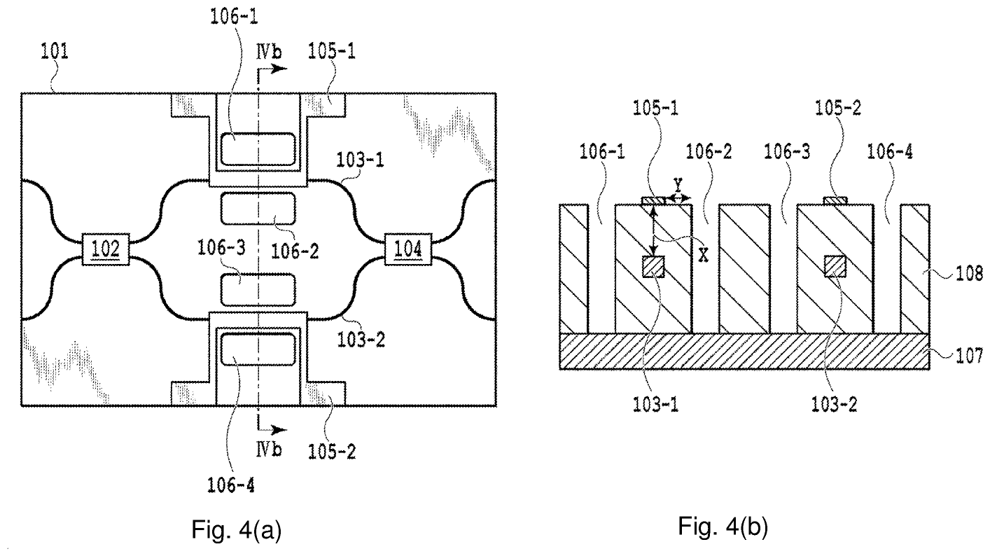

FIG. 4(a) shows a configuration of a waveguide type optical switch circuit according to a first embodiment of the present invention. FIG. 4(a) illustrates an outline of an optical system of an optical switch element of Mach-Zehnder interferometer type, and shows a configuration viewed from above. FIG. 4(b) is a cross-sectional view taken along the dashed line IVb-IVb in FIG. 4(a). Hereinafter, in the description of the present invention with reference to the drawings, the same components are given the same reference numerals.

An optical switch element 101 constituting the waveguide type optical switch circuit includes an optical splitter 102 that branches input signals, an optical coupler 104 that makes outputs of the optical splitter 102 recombine, interfere, and output, two arm waveguides 103 that connect the optical splitter 102 and the optical coupler 104, and thin film heaters 105 that are formed directly above the two arm waveguides 103 respectively. The optical switch element 101 includes heat insulating groove structures 106 for each of the two arm waveguides 103, and each groove structure 106 has a surface parallel to a side surface of the waveguide core of the arm waveguide.

In FIG. 4(b), the optical switch element 101 has a clad layer 108 stacked on a substrate 107, and the arm waveguides 103 are formed by the waveguide cores embedded in the clad layer 108. Thin film heaters 105 are formed on the upper surface of the clad layer 108 above the waveguide cores of the arm waveguides 103. The heat insulating groove structures 106 are formed by removing the clad layer in the vertical direction of the substrate on both sides of the two arm waveguides 103-1, 103-2. Here, the distance X between the waveguide core of the arm waveguide 103 and the thin film heater 105 is designed to be equal to or greater than the distance Y between the thin film heater 105 and the heat insulating groove structure 106 (X≥Y).

An example of desirable material for the substrate 107 may include a silicon substrate. Examples of desirable materials for the clad layer 108 and the optical switch element 101 may include quartz-based glass containing SiO₂ as a main component.

As an example of desirable design of the arm waveguides 103, the two waveguides may be of equal length. In this case, when the upper port of the optical splitter 102 is used as the input port of the optical switch element 101 in FIG. 4(a), the optical signal is outputted to the lower port of the optical coupler 104 with the voltage applied to the thin film heaters 105 being zero.

As an example of desirable design of the arm waveguides 103, an optical path length difference between the two waveguides may be λ/2 with respect to the wavelength λ of the signal light. In this case, when the upper port of the optical splitter 102 is used as the input port of the optical switch element 101 in FIG. 4(a), the optical signal is outputted to the upper port of the optical coupler 104 with the voltage applied to the thin film heaters 105 being zero.

When a voltage is applied to the thin film heater 105, heat is generated. The generated heat propagates through the clad layer to heat the waveguide core of the arm waveguide 103 located below the thin film heater 105. The refractive index of the heated waveguide core changes due to the thermo-optic effect, and the optical path length of the arm waveguide 103 is thereby changed. When the amount of change in the optical path length reaches λ/2 with respect to the wavelength λ of the signal light, the phase of the signal inputted to the optical coupler 104 through the arm waveguide 103 is changed by π, that is, inverted. Accordingly, the output port of the optical signal is switched.

The thermal conductivity of air (0.0241 W/m/K) present in the heat insulating groove structure 106 is lower than that of the material of the clad layer 108 (for example, 1.4 W/m/K for SiO₂). Due to the difference in thermal conductivity, the heat generated in the thin film heater 105 is blocked from diffusing in the horizontal direction of the substrate by the heat insulating groove structure 106, and propagates in the vertical direction of the substrate 107.

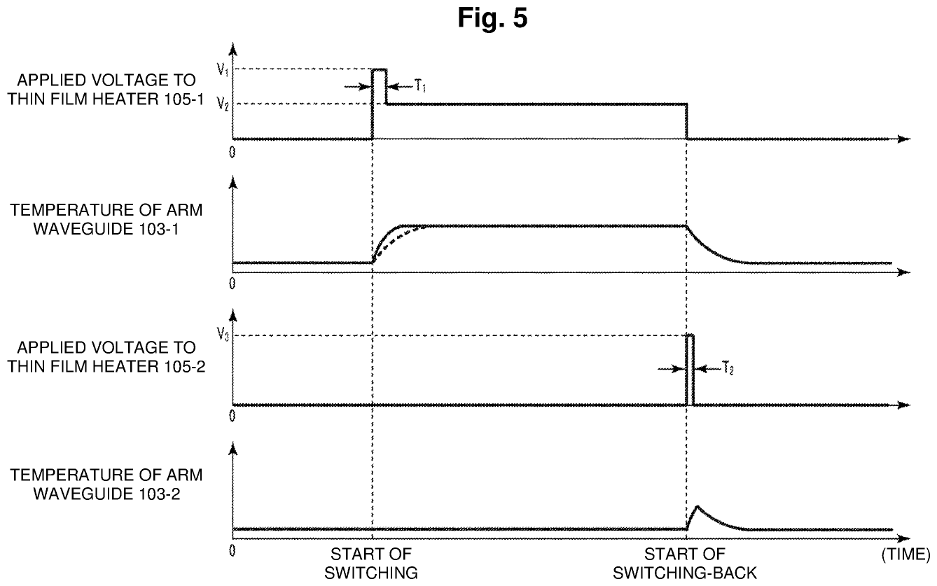

FIG. 5 is a timing diagram of switching and switching-back of the output port of the waveguide type optical switch circuit according to the first embodiment. V₂ represents the voltage applied to the thin film heater 105 to generate the amount of heat per unit time required to change the optical path length of the arm waveguide 103 by λ/2 in the thermal equilibrium state.

When the output port of the optical switch element 101 is switched (in the initial stage of switching), a voltage V₁ sufficiently higher than the voltage V₂ is applied to the thin film heater 105-1 for an appropriate period of time T₁, and after the lapse of T₁, the voltage V₂ is applied. As a result, the time is reduced that elapses before the arm waveguide 103-1 located directly below the thin film heater 105-1 reaches a temperature at which its optical path length is changed by λ/2. For comparison, the dashed line in FIG. 5 shows the temperature change of the arm waveguide 103-1 when the voltage V₂ is continuously applied from the initial stage of switching. Generating a large amount of heat in the arm waveguide 103-1 in the initial stage of switching allows reduction in time required for switching of the output port of the optical switch element 101.

The following describes the case in which the output port of the optical switch element 101 is switched back at a state that the output port of the optical switch element 101 has been switched, that is, a state that the optical path length of the arm waveguide 103-1 has been changed by λ/2 by the addition of heat. In general, the voltage applied to the thin film heater 105-1 located directly above the arm waveguide 103-1 is set to zero, and then the arm waveguide 103-1 is cooled and the amount of change in the optical path length is returned to zero. In the present embodiment, a voltage is applied to the thin film heater 105-2 additionally for a predetermined period of time to heat the arm waveguide 103-2 so that the amounts of change in the optical path lengths of both waveguides become equal.

In this case, even when the output port of the optical switch element 101 has been switched back, the two arm waveguides 103-1, 103-2 are in a heated state different from the initial state. For the next switching at this state, a combination of applied voltage and application time different from that for the initial state is required. Therefore, the two arm waveguides 103-1, 103-2 are desirably allowed to dissipate heat with the amounts of change in their optical path lengths kept equal to return the amounts of change in the optical path lengths to zero before the next switching.

Specifically, when the output port of the optical switch element 101 is switched back (in the initial stage of switching-back), a voltage applied to the thin film heater 105-1 is set to zero. At the same time, a sufficiently high voltage V₃ is applied to the thin film heater 105-2 for an appropriate period of time T₂ and then the applied voltage is set to zero to heat the arm waveguide 103-2. As a result, the two arm waveguides 103-1, 103-2 have the same temperature and the same amount of change in the optical path length, and the output port of the optical switch element 101 is thereby switched back.

Compared with the case of setting the applied voltage to the thin film heater 105-1 to zero and waiting until the amount of change in the optical path length returns to zero, generating a larger amount of heat in the thin film heater 105-2 in the initial stage of switching-back allows the amounts of change in the optical path lengths of the two arm waveguides 103-1, 103-2 to become equal and the output port of the optical switch element 101 to be switched back in a shorter time.

When the output port of the optical switch element 101 is switched again after switching-back, the parameter for the applied voltage pulse does not need to be changed. In other words, it is desirable to allow switching with a combination of the voltage V₁ and the period of time T₁ and to cool the two arm waveguides 103-1, 103-2 into a sufficiently cooled state with the lapse of a certain period of time T₃ since the start of switching-back, before switching.

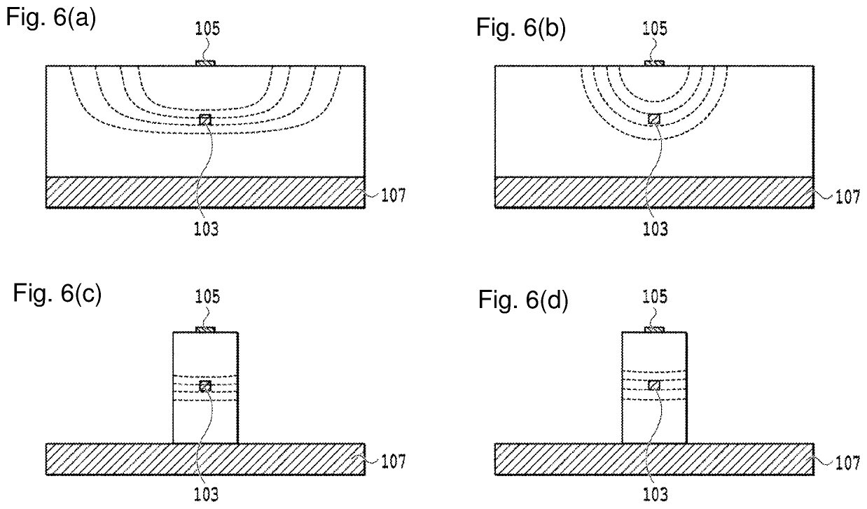

According to the method of switching and switching-back of the output port of the waveguide type optical switch circuit shown in FIG. 5, the time required for switching and switching-back can be reduced regardless of the presence or absence of the heat insulating groove structure. In addition, with the heat insulating groove structure provided, the distance (X) between the waveguide core of the arm waveguide 103 and the thin film heater 105 is designed to be equal to or greater than the distance (Y) between the thin film heater 105 and the heat insulating groove structure 106 (X≥Y), and more remarkable effect can thereby be achieved. This effect is described below through a comparison between with and without the heat insulating groove structure with reference to FIG. 6.

The operation for switching-back of the optical switch element 101 without the heat insulating groove 106 formed therein is described. The applied voltage to the thin film heater 105-1 is set to zero so that the heat supply is stopped, and then the arm waveguide 103-1 is cooled at the thermal equilibrium state in which the voltage V₂ is applied to the thin film heater 105. In the absence of the heat insulating groove, isothermal lines in the cross section of the arm waveguide 103-1 in the thermal equilibrium state have a pattern similar to that of equipotential lines formed when the thin film heater 105-1 is regarded as a point charge and the substrate 107 as a flat plate electrode from electrodynamical standpoint. As shown in FIG. 6(a), the isothermal lines parallel to the substrate 107 is formed in the vicinity of the waveguide core of the arm waveguide 103-1. In this case, in the cooling process after the heat supply is stopped, the direction of the heat flow path is limited to the vertical direction of the substrate.

The voltage V₃ is applied to the thin film heater 105-2 for the period of time T₂, and then the arm waveguide 103-2 is rapidly heated at the sufficiently cooled state. After the arm waveguide 103-2 reaches the same temperature as that of the arm waveguide 103-1, the applied voltage to the thin film heater 105-2 is set to zero so that the heat supply is stopped, and then the arm waveguide 103-2 is cooled.

The resulting isothermal lines are hardly affected by the substrate 107, and have a concentric pattern about the thin film heater 105-2 as shown in FIG. 6(b) and a curved pattern also in the vicinity of the waveguide core of the arm waveguide 103-2. When the heat supply is stopped in this heat distribution, the heat flow path in the subsequent cooling process is different from that in the heat distribution shown in FIG. 6(a), and a partial amount of heat propagates in the direction horizontal to the substrate having a temperature differential.

Therefore, comparing the case that the heat supply is stopped at the thermal equilibrium state and the case that the heat supply is stopped after rapid heating as for the temperature change of the two arm waveguides 103-1, 103-2, the latter case involving cooling with the heat propagation in the direction horizontal to the substrate results in more quick cooling and a temperature differential between the two arm waveguides 103-1, 103-2.

Next, the operation for switching-back of the optical switch element 101 with the heat insulating groove 106 formed therein is described. The applied voltage to the thin film heater 105-1 is set to zero so that the heat supply is stopped, and then the arm waveguide 103-1 is cooled at the thermal equilibrium state in which the voltage V₂ is applied to the thin film heater 105. In the presence of the heat insulating groove, the heat is blocked from propagating by the heat insulating groove, and the obstructed heat propagates in the vertical direction of the substrate 107. As a result, the thermal equilibrium state is achieved with a smaller amount of heat supply. As shown in FIG. 6(c), the isothermal lines in the vicinity of the waveguide core of the arm waveguide 103-1 have a pattern parallel to the substrate 107 as with the case without the heat insulating groove. Therefore, in the cooling process after the heat supply is stopped, the direction of the heat flow path is limited to the vertical direction of the substrate as with the case without the heat insulating groove.

The voltage V₃ is applied to the thin film heater 105-2 for the period of time T₂, and then the arm waveguide 103-2 is rapidly heated at a sufficiently cooed state. After the arm waveguide 103-2 reaches the same temperature as that of the arm waveguide 103-1, the applied voltage to the thin film heater 105-2 is set to zero so that the heat supply is stopped, and then the arm waveguide 103-2 is cooled.

The resulting isothermal lines propagate concentrically about the thin film heater 105-2. When the distance (Y) between the thin film heater 105-2 and each of the heat insulating grooves 106-3, 4 is equal to or smaller than the distance (X) between the waveguide core of the thin film heater 105-2 and the arm waveguide 103-2 (X≥Y), the heat propagation is blocked by the heat insulating grooves 106 at the same timing as or earlier than the timing when the arm waveguide 103-2 starts to be heated. The obstructed heat propagates in the vertical direction of the substrate 107. Due to this effect, when the two arm waveguides 103 reach the same temperature, the resulting isothermal lines are substantially parallel to the substrate 107, as shown in FIG. 6(d). Therefore, in the cooling process after the heat supply is stopped, the dominant direction of the heat flow path is the vertical direction of the substrate, as with the case of the arm waveguide 103 starting at the thermal equilibrium state.

With the heat insulating groove 106 formed at a short distance from the thin film heater and the arm waveguide, both the case that the heat supply is stopped at the thermal equilibrium state and the case that the heat supply is stopped after rapid heating result in much the same heat distribution and thus much the same temperature change in the two arm waveguides 103.

It is easy to understand that an event similar to the above occurs when the optical switch element 101 is switched. When the heat insulating groove 106 is not formed, the voltage V₁ is applied to the thin film heater 105-1 for the period of time T₁, and then the arm waveguide 103-1 is rapidly heated and reaches a temperature causing a change in the optical path length of λ/2. After that, the heat is supplied to maintain the thermal equilibrium state. The isothermal lines immediately after the rapid heating have a concentric pattern about the thin film heater 105-2, as shown in FIG. 6(b). Because the heat in part escapes through propagation in the direction horizontal to the substrate having a temperature differential, the temperature temporarily decreases.

With the heat insulating groove 106 formed at a short distance from the thin film heater and the arm waveguide, isothermal lines having much the same pattern as that in thermal equilibrium state and being parallel to the substrate 107 are formed in a stage that the arm waveguide reaches a temperature causing a change in the optical path length of λ/2 through rapid heating (FIG. 6(d)). Therefore, the heat does not escape in the direction horizontal to the substrate and the arm waveguide shifts to the thermal equilibrium state while keeping the temperature.

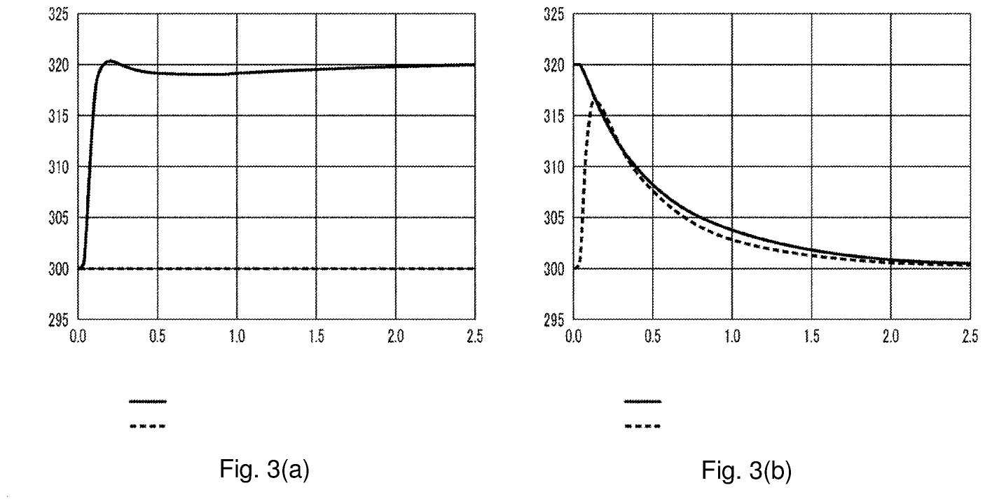

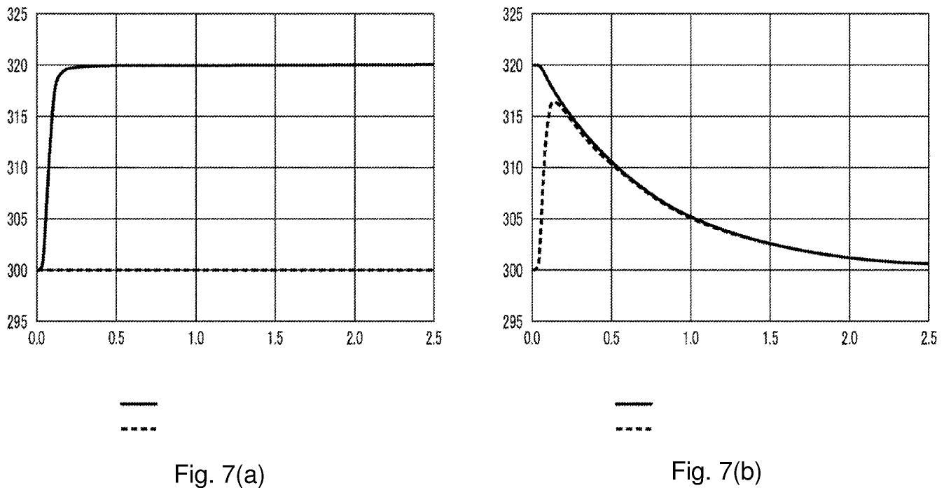

FIG. 7(a) shows an example of simulation of temperature change in switching in the waveguide type optical switch circuit according to the first embodiment, demonstrating the temperature change when the distance (X) between the waveguide core of the arm waveguide 103 and the thin film heater 105 is designed to be equal to the distance (Y) between the thin film heater 105 and the heat insulating groove structure 106 (X=Y). For the case of the prior art without the heat insulating groove structure shown in FIG. 3(a), the temperature of the waveguide once reaches a desired temperature in switching, and then the temperature temporarily decreases. In this embodiment, such an event does not occur.

FIG. 7(b) shows an example of simulation of temperature change in switching-back in the waveguide type optical switch circuit according to the first embodiment. The two arm waveguides reach substantially the same temperature in switching-back, and then reach the temperature of the substrate following much the same temperature change. Unlike the case of the prior art without the heat insulating groove structure as shown in FIG. 3(b), the temperature changes of the two waveguides are not different.

Therefore, decrease in transmittance (light output level) after switching of the optical switch and leakage light for a short time after switching-back of the optical switch do not occur. According to the present embodiment, as for the operation for switching and switching-back of the optical switch, the waveguide type optical switch circuit can be provided which stabilizes optical output after switching, does not cause leakage light after switching-back, and needs a short time for switching and switching-back.

### Second Embodiment

The optical system of the optical switch element of Mach-Zehnder interferometer type constituting a waveguide type optical switch circuit of a second embodiment is the same as that of the first embodiment, and the description thereof is omitted and the same reference numerals is used for description.

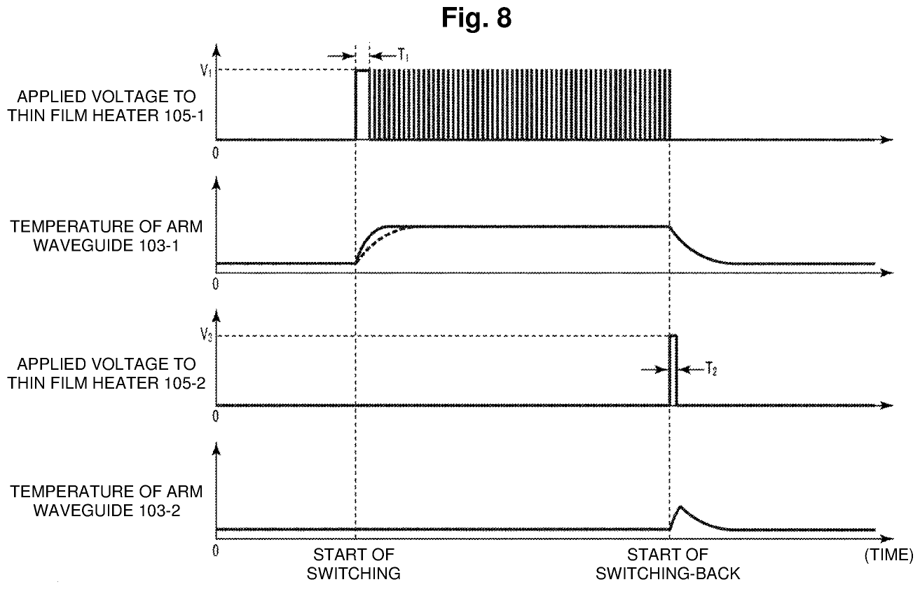

FIG. 8 is a timing diagram of switching and switching-back of the output port of the waveguide type optical switch circuit according to the second embodiment of the present invention. represents the voltage applied to the thin film heater 105 to generate the amount of heat per unit time required to change the optical path length of the arm waveguide 103 by λ/2 in the thermal equilibrium state.

When the output port of the optical switch element 101 is switched (in the initial stage of switching), a voltage V₁ sufficiently higher than the voltage V₂ is applied to the thin film heater 105-1 for an appropriate period of time T₁. After the lapse of T₁, a period of time when the voltage V₁ is not applied, (1−V₂²/V₁²)×T₃ (where T₃ is a sufficiently short period of time with respect to the response time of the thermo-optic effect of the waveguide core of the arm waveguide 103-1), and a period of time when the voltage V₁ is applied, V₂²/V₁²×T₃, are alternately repeated. Considering the time-average voltage, the same power as that when the voltage V₂ is applied is thereby supplied. As a result, the time is reduced that elapses before the arm waveguide 103-1 located directly below the thin film heater 105-1 reaches a temperature at which its optical path length is changed by λ/2.

For comparison, the dashed line in FIG. 8 shows the temperature change of the arm waveguide 103-1 when the voltage V₂ is continuously applied from the initial stage of switching. After a large amount of heat is generated in the arm waveguide 103-1 in the initial stage of switching and the arm waveguide 103-1 reaches a target temperature, power required to maintain the thermal equilibrium state at the target temperature is supplied. As a result, the time required for switching of the output port of the optical switch element 101 can be reduced. Further, limiting the voltage applied to the thin film heater 105 to only V₁ allows the electric circuit for applying the voltage to be simplified.

The following describes the case in which the output port of the optical switch element 101 is switched back at a state that the optical switch element 101 has been switched, that is, a state that the optical path length of the arm waveguide 103-1 has been changed by λ/2 by the addition of heat. In general, the power supply to the thin film heater 105-1 located directly above the waveguide core of the arm waveguide 103-1 is stopped, and then the arm waveguide 103-1 is cooled and the amount of change in the optical path length is returned to zero. In the present embodiment, the arm waveguide 103-2 is additionally heated for a predetermined period of time (T₂) so that the amounts of change in both optical path lengths become equal.

In this case, even when the output port of the optical switch element 101 has been switched back, the two arm waveguides 103-1, 103-2 are in a heated state different from the initial state. For the next switching at this state, a combination of applied voltage and application time different from those for the initial state is required. Therefore, the two arm waveguides 103-1, 103-2 are desirably allowed to dissipate heat with the amounts of change in their optical path lengths kept equal to return the amounts of change in the optical path lengths to zero before the next switching.

Specifically, when the output port of the optical switch element 101 is switched back (in the initial stage of switching-back), a voltage applied to the thin film heater 105-1 is set to zero. At the same time, a sufficiently high voltage V₃ is applied to the other thin film heater 105 for an appropriate period of time 12 to heat the other arm waveguide 103. As a result, the two arm waveguides 103-1, 103-2 have the same temperature and the same amount of change in the optical path length, and the output port of the optical switch element 101 is thereby switched back. In particular, equating the voltage V₃ applied to the thin film heater 105-2 and the voltage V₁ applied to the thin film heater 105-1 allows the electric circuit for applying the voltage to be more simplified.

Compared with the case of setting the applied voltage to the thin film heater 105-1 to zero and waiting until the amount of change in the optical path length returns to zero, generating a larger amount of heat in the thin film heater 105-2 in the initial stage of switching-back allows the amounts of change in the optical path lengths of the two arm waveguides 103-1, 103-2 to become equal and the output port of the optical switch element 101 to be switched back in a shorter time.

When the output port of the optical switch element 101 is switched again, the parameter for the applied voltage pulse does not need to be changed. In other words, it is desirable to allow switching with a combination of the voltage V₁ and the period of time T₁ and to cool the two arm waveguides 103-1, 103-2 into a sufficiently cooled state with the lapse of a certain period of time T₄ since the start of switching-back, before switching.

According to the present embodiment, power consumption is reduced through application of the heat insulating groove structure and the pulsed voltage is applied to the thin film heater in the initial stages of switching and switching-back of the optical switch element, and thus, the waveguide type optical switch circuit that needs a short time for switching and switching-back can be provided.

### INDUSTRIAL APPLICABILITY

Applying the waveguide type optical switch circuit of the present invention in optical communication networks allows both lower power consumption and a shorter time required for switching and switching-back than those of conventional waveguide type optical switch circuits.

1. A waveguide type optical switch circuit comprising:
a waveguide that has a clad layer stacked on a substrate and a waveguide core embedded in the clad layer;
a heater that is formed on an upper surface of the clad layer above the waveguide core; and
a groove that is obtained by removing the clad layer in a vertical direction of the substrate and has a surface parallel to a side surface of the waveguide core,
wherein a distance between the waveguide core and the heater is equal to or greater than a distance between the heater and the groove.

2. A waveguide type optical switch circuit of Mach-Zehnder interferometer type, which includes an optical splitter that branches input signals, an optical coupler that makes outputs of the optical splitter recombine, interfere, and output, and two arm waveguides that connect the optical splitter and the optical coupler, each arm waveguide having a clad layer stacked on a substrate and a waveguide core embedded in the clad layer, the waveguide type optical switch circuit comprising:
heaters that are formed on an upper surface of the clad layer above the waveguide cores; and
grooves that are obtained by removing the clad layer in a vertical direction of the substrate, each of the grooves having a surface parallel to a side surface of the waveguide core,
wherein a distance between the waveguide core and the heater is equal to or greater than a distance between the heater and the groove.

3. The waveguide type optical switch circuit according to claim 2, wherein lengths of the two arm waveguides are designed so that, in a state that voltages applied to the respective heaters for the two arm waveguides are zero, an optical signal is outputted to one of output ports of the optical coupler.

4. The waveguide type optical switch circuit according to claim 1, wherein the substrate is a silicon substrate, and the clad layer and the waveguide core are made of quartz-based glass containing SiO₂ as a main component.

5. A driving method for a waveguide type optical switch circuit of Mach-Zehnder interferometer type, which includes an optical splitter that branches input signals, an optical coupler that makes outputs of the optical splitter recombine, interfere, and output, two arm waveguides that connect the optical splitter and the optical coupler, each arm waveguide having a clad layer stacked on a substrate and a waveguide core embedded in the clad layer, and heaters that are formed on an upper surface of the clad layer above the waveguide cores, the driving method comprising:
in switching of an output port of the optical coupler, applying a first voltage having a high voltage value to one of the heaters for a first period of time, and then applying a second voltage lower than the first voltage; and
in switching-back of the output port of the optical coupler, setting the voltage applied to the one heater to zero and applying a third voltage to the other one of the heaters for a second period of time, and then setting the applied voltage to zero.

6. (canceled)

7. (canceled)

8. The driving method for the waveguide type optical switch circuit according to claim 5, wherein after the output port of the optical coupler is switched back, a third period of time or a period of time longer than the third period of time is allowed to elapse before the output port of the optical coupler is switched again.

9. The waveguide type optical switch circuit according to claim 2, wherein the substrate is a silicon substrate, and the clad layer and the waveguide core are made of quartz-based glass containing SiO₂ as a main component.

10. The waveguide type optical switch circuit according to claim 3, wherein the substrate is a silicon substrate, and the clad layer and the waveguide core are made of quartz-based glass containing SiO₂ as a main component.
